(19) United States
(12) Patent Application Publication
(10) Pub. No.: US 2026/0307664 A1
(43) Pub. Date: Oct. 8, 2026

(54) APPARATUS AND METHOD FOR CONTROLLING HYBRID VEHICLE, AND HYBRID VEHICLE HAVING SAME

(71) Applicants: Hyundai Motor Company, Seoul (KR); Kia Corporation, Seoul (KR)

(72) Inventors: Jung Un AN, Hwaseong-si (KR); Min Su KIM, Hwaseong-si (KR); Gi Young KWON, Hwaseong-si (KR); Gee Wook SHIN, Hwaseong-si (KR)

(73) Assignees: Hyundai Motor Company, Seoul (KR); Kia Corporation, Seoul (KR)

(21) Appl. No.: 19/362,128

(22) Filed: Oct. 17, 2025

(30) Foreign Application Priority Data
Apr. 2, 2025 (KR) 10-2025-0043094

(51) Int. Cl. B60W 50/00; B60W 10/06; B60W 10/11; B60W 10/18; B60W 10/26; B60W 20/13

(52) U.S. Cl. CPC B60W 50/0098; B60W 10/06; B60W 10/11; B60W 10/18; B60W 10/26; B60W 20/13; B60W 2510/06; B60W 2510/244; B60W 2520/04; B60W 2540/041; B60W 2710/06; B60W 2710/1005; B60W 2710/186; B60W 2710/244

(57) ABSTRACT

An apparatus for controlling a hybrid vehicle includes a hybrid powertrain including an engine and a drive motor, and a controller determining an operation state of the vehicle based on vehicle state information when entering a safe boarding and alighting mode, and maintaining the engine in an OFF state and limiting a driving force output of the hybrid powertrain when the operation state of the vehicle is in an boarding and alighting available state.

### CROSS REFERENCE TO RELATED APPLICATION

The present application claims priority to Korean Patent Application No. 10-2025-0043094, filed Apr. 02, 2025, the entire contents of which are incorporated herein for all purposes by this reference.

### FIELD OF THE PRESENT DISCLOSURE

The present disclosure relates to vehicle control, and more particularly, to an apparatus and a method for controlling a hybrid vehicle, and a hybrid vehicle having the same, wherein the vehicle control apparatus is implemented to ensure the state of charge (SOC) value of a battery in advance in consideration of boarding and alighting of a vehicle user, preventing an engine from starting to charge the battery in a stop state, and ensuring the safety of the vehicle user during boarding or alighting.

### BACKGROUND

When the SOC value of a high-voltage battery in a hybrid vehicle with an engine and a motor as a power source is reduced equal to or less than a certain level, engine starting may occur or persist while the vehicle is in a stop state to charge the high-voltage battery.

When the engine starts while a vehicle user enters or exits the vehicle, the exhaust gas can negatively impact the health of the vehicle user.

An engine start strategy is an operational strategy focusing on the state of the vehicle and does not consider the boarding and alighting of vehicle users, and the vehicle driving force control strategy does not take into account the boarding and alighting of a vehicle user.

In particular, since a high percentage of child traffic accidents occur during the boarding and alighting, the engine start strategy and vehicle driving force control strategy in consideration of the boarding and alighting of a vehicle user are required.

The matters described above as background technology are intended to provide a better understanding of the context of the present disclosure and are not intended to form a disclaimer of the related art known to those of ordinary skill in the art.

### BRIEF SUMMARY

In various aspects of the present disclosure, the present disclosure is provided to solve the above problem, an objective of the present disclosure is to provide an apparatus and a method for controlling a hybrid vehicle, and a hybrid vehicle including the same, the vehicle control apparatus being implemented to ensure the SOC value of a battery in advance in consideration of boarding and alighting of a vehicle user, preventing an engine from starting to charge the battery in a stop state.

In various aspects of the present disclosure, the present disclosure is to provide an apparatus and a method for controlling a hybrid vehicle, and a hybrid vehicle including the same, the vehicle control apparatus being implemented to ensure the SOC value of a battery in advance to limit starting of engine in a stop state when the vehicle enters a safe boarding and alighting mode.

In various aspects of the present disclosure, the present disclosure is to provide an apparatus and a method for controlling a hybrid vehicle, and a hybrid vehicle including the same, the vehicle control apparatus being implemented to prevent a vehicle user boarding and alighting the vehicle from being exposed to exhaust gas by performing an engine start limitation in a stop state of the vehicle to block engine operation to charge the battery.

In various aspects of the present disclosure, the present disclosure is to provide an apparatus and a method for controlling a hybrid vehicle, and a hybrid vehicle including the same, the vehicle control apparatus being implemented to limit a driving force of the vehicle when the vehicle is in a stop state and a vehicle door is opened, preventing generation of a driving force of the vehicle even when a driver accidentally shifts a transmission gear and manipulates an accelerator pedal, and ensuring the safety of a vehicle user boarding and alighting the vehicle and preventing vehicle slipping from occurring on a slope, and the like.

The technical problems to be achieved in the present disclosure are not limited to the above technical problem, and other problems not mentioned will be clearly understood by those skilled in the art from the description below.

In various aspects of the present disclosure, an apparatus for controlling a hybrid vehicle includes a hybrid powertrain including an engine and a drive motor; and a controller configured for determining an operation state of the vehicle based on vehicle state information when entering a safe boarding and alighting mode, and maintaining the engine in an OFF state and controlling a driving force output of the hybrid powertrain when the operation state of the vehicle is in a boarding and alighting available state.

In various aspects of the present disclosure, the boarding and alighting available state may be a state in which a stop condition is satisfied with a door of the vehicle opened.

In various aspects of the present disclosure, when the stop condition is satisfied, the controller may be configured for controlling the engine so that the engine may be maintained in the OFF state.

In various aspects of the present disclosure, when the door of the vehicle is opened, the controller may be configured for controlling the driving force output of the hybrid powertrain.

In various aspects of the present disclosure, when entering the safe boarding and alighting mode, the controller may be configured for controlling a battery so that a state of charge (SOC) value of the battery may reach a preset safe boarding and alighting charging target SOC value.

In various aspects of the present disclosure, the preset safe boarding and alighting charging target SOC value may be preset greater than or equal to electric power consumed by an electric field load of the vehicle when the vehicle is in a stop state.

In various aspects of the present disclosure, when the operation state of the vehicle is in the stop state, the controller may be configured to determine a door state of the vehicle based on the door state information, and when the door state of the vehicle is an open state, the controller may be configured for controlling the driving force output of the hybrid powertrain.

In various aspects of the present disclosure, when the driving force output of the hybrid powertrain is limited, the controller may be configured for controlling a transmission gear of the vehicle so that the transmission gear may be maintained in an N position.

In various aspects of the present disclosure, when the driving force output of the hybrid powertrain is limited, the controller may be configured for controlling an electronic parking brake of the vehicle so that the electronic parking brake is in an engaged state.

In various aspects of the present disclosure, the controller may include: a communication module communicating with electronic devices in the vehicle; a memory storing at least an algorithm of performing the safe boarding and alighting mode; and a processor entering the safe boarding and alighting mode, and performing the algorithm of performing the safe boarding and alighting mode.

In various aspects of the present disclosure, there is provided a method for controlling a hybrid vehicle including a hybrid powertrain including an engine and a drive motor, the method being performed by a processor operated based on an algorithm of performing a safe boarding and alighting mode, which is stored in a memory, and the method may include: entering a safe boarding and alighting mode; determining a vehicle operation state based on vehicle state information; and when the vehicle operation state is in an boarding and alighting available state, maintaining the engine in an OFF state and limiting a driving force output of the hybrid powertrain.

In various aspects of the present disclosure, the boarding and alighting available state may be a state in which a stop condition is satisfied with a door of the vehicle opened.

In various aspects of the present disclosure, the maintaining of the engine in the OFF state may be performed when the stop condition is satisfied.

In various aspects of the present disclosure, the control of the driving force output of the hybrid powertrain may be performed when the door of the vehicle is opened.

In various aspects of the present disclosure, the method may further include: when entering the safe boarding and alighting mode, controlling a battery of the vehicle so that a state of charge (SOC) value of the battery reaches a preset safe boarding and alighting charging target SOC value.

In various aspects of the present disclosure, the preset safe boarding and alighting charging target SOC value may be set greater than or equal to electric power consumed by an electric field load of the vehicle when the vehicle is in a stop state.

In various aspects of the present disclosure, the controlling of the driving force output of the hybrid powertrain may include maintaining a transmission gear of the vehicle in an N position.

In various aspects of the present disclosure, the controlling of the driving force output of the hybrid powertrain may include maintaining the electronic parking brake of the vehicle in an engaged state.

In various aspects of the present disclosure, there is provided a hybrid vehicle including a hybrid powertrain including an engine and a drive motor, and the hybrid vehicle may include: a vehicle control apparatus, when entering a safe boarding and alighting mode, which controls the hybrid vehicle based on a preset algorithm for performing the safe boarding and alighting mode, wherein the vehicle control apparatus may be configured to determine an operation state of the vehicle based on vehicle state information, and when the vehicle operation state is in an boarding and alighting available state, the vehicle control apparatus may maintain the engine in an OFF state and control a driving force output of the hybrid powertrain.

In various aspects of the present disclosure, the vehicle control apparatus may include: a user interface configured to receive an instruction of entering a safe boarding and alighting mode from a user; and a controller including a processor configured to enter the safe boarding and alighting mode, and perform the preset algorithm for performing the safe boarding and alighting mode.

Specific details according to various examples of the present disclosure, other than the solutions mentioned above, are included in the description and the drawings below.

In various aspects of the present disclosure, the vehicle control apparatus is implemented to ensure the SOC value of the battery in advance, in consideration of the vehicle user boarding and alighting the vehicle, preventing the engine from starting to charge the battery in a stop state.

When the apparatus and the method for controlling a hybrid vehicle in various aspects of the present disclosure are applied to the vehicle, it is possible to prevent a vehicle user from being exposed to exhaust gas when the vehicle user enters and exits the vehicle, and to ensure the safety of the vehicle user boarding and alighting the vehicle. Furthermore, the productivity of the vehicle and the customer satisfaction may be improved.

The apparatus and the method for controlling a hybrid vehicle in various aspects of the present disclosure are applied to a vehicle (school transportation) used to transport children to or from a school so that it is possible to prevent the children from having an accident and being exposed to exhaust gas when they enter and exit the vehicle.

The effect of the present disclosure is not limited to the above-mentioned effects, and other effects not mentioned will be clearly understood by those skilled in the art from the description below.

### BRIEF DESCRIPTION OF THE DRAWINGS

The accompanying drawings are intended to illustrate an exemplary embodiment of the present disclosure and provide examples with a detailed description. However, the technical features of the exemplary embodiments are not limited to any drawings, and the features included in each drawing may be combined with each other to form new embodiments.

FIG. 1 is a view showing an example of configuration of a vehicle control apparatus according to the exemplary embodiment of the present disclosure.

FIG. 2 is a view showing an example of configuration of the controller according to the exemplary embodiment of the present disclosure.

FIG. 3 is a view exemplarily illustrating a method for controlling the vehicle control apparatus according to the exemplary embodiment of the present disclosure.

FIG. 4 is a view showing a power system of a vehicle to which the vehicle control apparatus according to the exemplary embodiment of the present disclosure is applied.

FIG. 5 is a view showing a control block diagram for realizing control of the vehicle according to the exemplary embodiment of the present disclosure.

### DETAILED DESCRIPTION OF THE PRESENT DISCLOSURE

In the following description, if it is decided that the detailed description of known technologies related to the present disclosure makes the subject matter of the exemplary embodiment described herein unclear, the detailed description is omitted. Furthermore, the accompanying drawings are provided only for easy understanding of the exemplary embodiment included in the specification, and the technical spirit included in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

Singular forms are intended to include plural forms unless the context clearly indicates otherwise.

It will be further understood that the terms “comprise” or “have” used in the present specification, specify the presence of stated features, steps, operations, components, parts, or a combination thereof, but do not preclude the presence or addition of one or more other features, numerals, steps, operations, components, parts, or a combination thereof.

The suffixes “module” and “part” for the components used in the following description are given or mixed in consideration of only the ease of writing the specification, and do not have distinct meanings or roles by themselves.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element intervening therebetween.

Furthermore, a unit or a control unit included in names is only a widely used term for a controller that controls a specific function of a vehicle, and does not mean a generic function unit

The controller may include a communication device communicating with other controllers or a sensor to control the function in charge, a memory storing an operation system or a logic command and input/output information, and at least one process performing determination, calculation, and decision necessary for controlling the function in charge.

In any of the configurations described in the specification, any number of components or a variety of components may be included within the present disclosure described herein. The components may include any combination of the features described herein and may be arranged in any of the various configurations described herein. In addition to structures and arrangements of the components of the present disclosure, the concept of use and operation thereof may be applied not only to the specific embodiments disclosed herein, but also to any number of embodiments in any combination. The exemplary embodiments including various features of various arrangements are described below with reference to the drawings.

Hereafter, the various embodiments of the present disclosure will be described in detail with reference to the accompanying drawings, and the same or similar components are provided the same reference numerals regardless of the numbers of figures and are not repeatedly described.

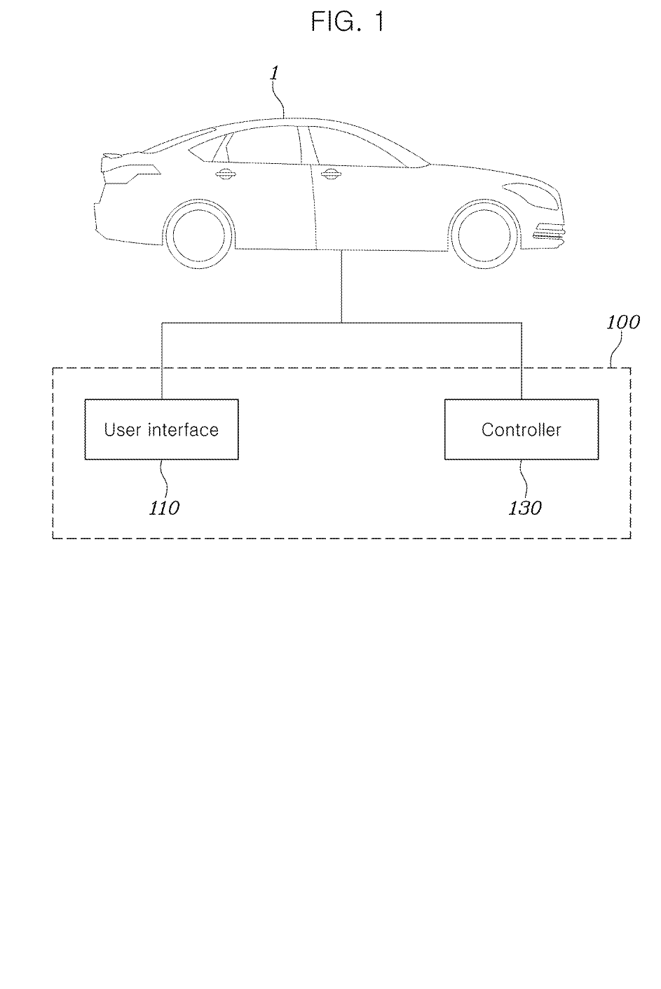

FIG. 1 is a view showing configuration of a vehicle control apparatus according to the exemplary embodiment of the present disclosure.

Referring to FIG. 1, the vehicle control apparatus 100 is disposed to a hybrid vehicle 1 (hereinbelow, which will be referred to as a vehicle), and when entering a safe boarding and alighting mode, the vehicle control apparatus 100 may be configured for controlling the vehicle 1 to ensure the safety of a vehicle user boarding and alighting the vehicle.

The hybrid vehicle 1 may include a hybrid powertrain including an engine and a motor as a driving source.

For example, the vehicle control apparatus 100 may enter a safe boarding and alighting mode according to a user's instruction. For example, when the vehicle enters a preset path or a preset time condition is satisfied, the vehicle control apparatus 100 may enter the safe boarding and alighting mode.

The vehicle control apparatus 100 includes a user interface 110 and a controller 130, and the configuration of the vehicle control apparatus 100 is not limited thereto.

According to the exemplary embodiment of the present disclosure, the user interface 110 may be implemented to receive a user's instruction. For example, the user interface 110 may be implemented to receive settings with respect to a vehicle mode. For example, the user interface 110 may receive an instruction of entering the safe boarding and alighting mode.

The user interface 110 may display a mode of the vehicle 1 according to the user's instruction. For example, when the user presets the safe boarding and alighting mode, the user interface 110 may display an entering state of the safe boarding and alighting mode. The user interface 110 may display information according to an instruction of the controller 130. For example, the user interface 110 may display information with respect to whether the engine is operated.

The user interface 110 may be implemented into at least one of an audio video navigation (AVN) system, an audio video navigation telecommunication (AVNT) system, a cluster, or a head up display, but the type of the user interface 110 is not limited thereto.

For example, the user interface 110 may provide a user setting mode (USM) for interfacing with the user.

The user may manipulate the USM provided in the user interface 110 to input a vehicle mode. For example, the user may manipulate the USM to activate (or set) the safe boarding and alighting mode.

According to the exemplary embodiment of the present disclosure, when entering the safe boarding and alighting mode, the controller 130 may be operated based on an algorithm for implementing a function according to the preset safe boarding and alighting mode (safe boarding and alighting mode performing algorithm).

When entering the safe boarding and alighting mode, the controller 130 may be configured to determine an operation state of the vehicle 1. When the vehicle 1 is in a travelling state, the controller 130 may be configured for controlling a battery of the vehicle 1 according to a preset safe boarding and alighting charging algorithm.

According to the exemplary embodiment of the present disclosure, the controller 130 may be configured to determine the operation state of the vehicle 1 based on the vehicle state information, such as vehicle speed information, transmission gear position information, emergency light state information, and the like.

For example, when the vehicle speed is less than or equal to a preset threshold speed, and a transmission gear is in a P position, the controller 130 may be configured to determine that the vehicle 1 is in a stop state. For example, when the vehicle speed is less than or equal to the preset threshold speed, the transmission gear is in the P position, and the emergency lights are on, the controller 130 may be configured to determine that the vehicle 1 is in the stop state.

According to the exemplary embodiment of the present disclosure, based on the preset safe boarding and alighting charging algorithm, the controller 130 may be configured for controlling the state of charge (SOC) value of the battery while considering the amount of the battery required by an electric field load in the stop state of the vehicle 1. For example, the electric field load includes air conditioning system, lighting system, infotainment system, etc.

To the present end, the controller 130 may store the information related to a preset safe boarding and alighting charging target SOC value. For example, when the vehicle control apparatus enters the safe boarding and alighting mode, the controller 130 may be configured for controlling charging of the battery so that the battery SOC value reaches the safe boarding and alighting charging target SOC value.

At the present point, the safe boarding and alighting charging target SOC value may be preset based on the electric power consumed by the electric field load of the vehicle 1 in the stop state of the vehicle 1, and may be preset by repeated tests.

When the battery of the vehicle 1 is greater than or equal to the safe boarding and alighting charging target SOC value, the battery charging based on engine start in the stop state of the vehicle 1 is not performed. In other words, the safe boarding and alighting charging target SOC value may be an SOC value preset to limit the battery charging based on engine start in the stop state of the vehicle 1.

When the vehicle control apparatus enters the safe boarding and alighting mode, and then the vehicle 1 is in the stop state, the controller 130 may perform engine start limitation. For example, the controller 130 may stop operation of the engine, and output the engine limiting state (or engine stop state) with the user interface 110.

At the present point, the engine start limitation may be performed by preventing the engine from starting before the safe boarding and alighting mode is released.

Accordingly, when the operation state of the vehicle 1 is in the stop state, the controller 130 may perform the engine start limitation and block the engine-based charging of the battery of the vehicle 1.

According to the exemplary embodiment of the present disclosure, the controller 130 may stop engine operation of the vehicle 1 until the operation state of the vehicle 1 is changed into a travelling state or an instruction of releasing the safe boarding and alighting mode is input.

After entering the safe boarding and alighting mode, when the door is opened in the stop state of the vehicle 1, the controller 130 may limit a driving force output of the vehicle 1. For example, the controller 130 may output a driving force limitation state through the user interface 110.

At the present point, the limiting the driving force output of the vehicle 1 may be performed by limiting powertrain output of the vehicle 1.

According to the exemplary embodiment of the present disclosure, the controller 130 may limit the driving force output of the vehicle 1 by maintaining the transmission gear in a Neutral (N) position, and fastening an electronic parking brake (EPB).

Likewise, when the controller 130 performs the driving force output limitation for the vehicle 1, even when the driver accidentally shifts the transmission gear and manipulate an accelerator pedal, it is possible to prevent the driving force of the vehicle 1 from being generated to ensure the safety of the vehicle user boarding and alighting the vehicle, and to prevent vehicle slipping from occurring on a slope, and the like.

For example, the controller 130 may be implemented into a single controller or a plurality of controllers as a form with distributed functions.

For example, the controller 130 may be implemented in combination of a battery management system (BMS) managing (or controlling) the battery 120 and a higher controller (e.g., vehicle control unit (VCU), a hybrid control unit (HCU), and an integrated central control unit (ICU), and the like).

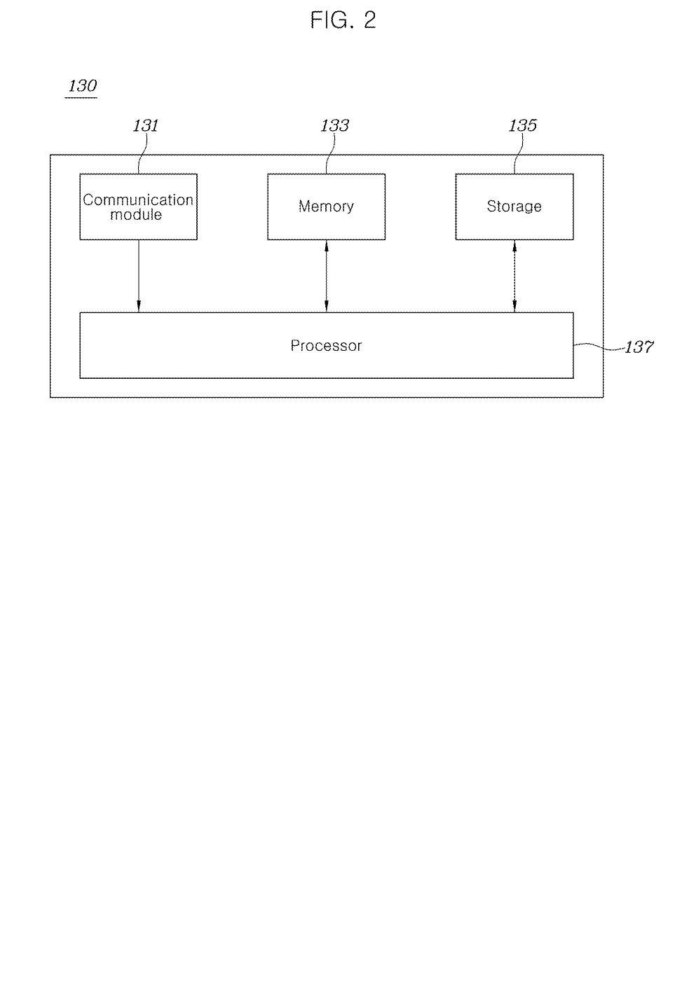

FIG. 2 is a view showing configuration of the controller 130 according to the exemplary embodiment of the present disclosure.

Referring to FIG. 2, the controller 130 may include a communication module 131, a memory 133, a storage 135, and a processor 137, and the configuration of the controller 130 is not limited thereto.

The communication module 131 may receive different types of external information. The information received by the communication module 131 may be transmitted to the processor 137, stored in the memory 133, and stored in the storage 135.

For example, the communication module 131 may include communication circuits implemented to communicate with in-vehicle sensors. For example, the communication module 131 may be implemented to perform communication based on transport protocol such as Local Interconnect Network (LIN), Controller Area Network (CAN), FlexRay, Ethernet, and the like.

For example, the communication module 131 may receive speed information from a speed sensor, transmission gear position information from a transmission gear position sensor, emergency light state information from an emergency light controller, and door opening and closing information from a door sensor, and the types of information are not limited thereto.

The memory 133 may store algorithms (or software or program), data, etc. required to perform the functions of the controller 130. For example, the memory 133 may store algorithms, data, etc., required to perform the safe boarding and alighting mode according to the exemplary embodiment of the present disclosure by the controller 130.

The storage 135 may store data or/and information generated or obtained according to the operation of the controller 130. For example, the storage 135 may store data or/and information received by the controller 130 from an external device.

For example, the memory 133 and the storage 135 may be implemented into one of storage mediums (or recovering mediums), such as a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, a web storage, and the like.

The processor 137 may perform the overall operation of the controller 130. The processor 137 may perform the safe boarding and alighting mode for the vehicle, based on the information received through the communication module 131, the algorithms/data stored in the memory 133, the information stored in the storage 135, and the like.

To the present end, the processor 137 may be a data processing apparatus implemented in hardware including a circuit with a physical structure for activating desired operations. For example, the desired operations may include code or instructions included in a program. For example, the data processing apparatus implemented in hardware may include a microprocessor, a central processing unit, a processor core, a multi-core processor, a multiprocessor, an application-specific integrated circuit (ASIC), and a field programmable gate array (FPGA).

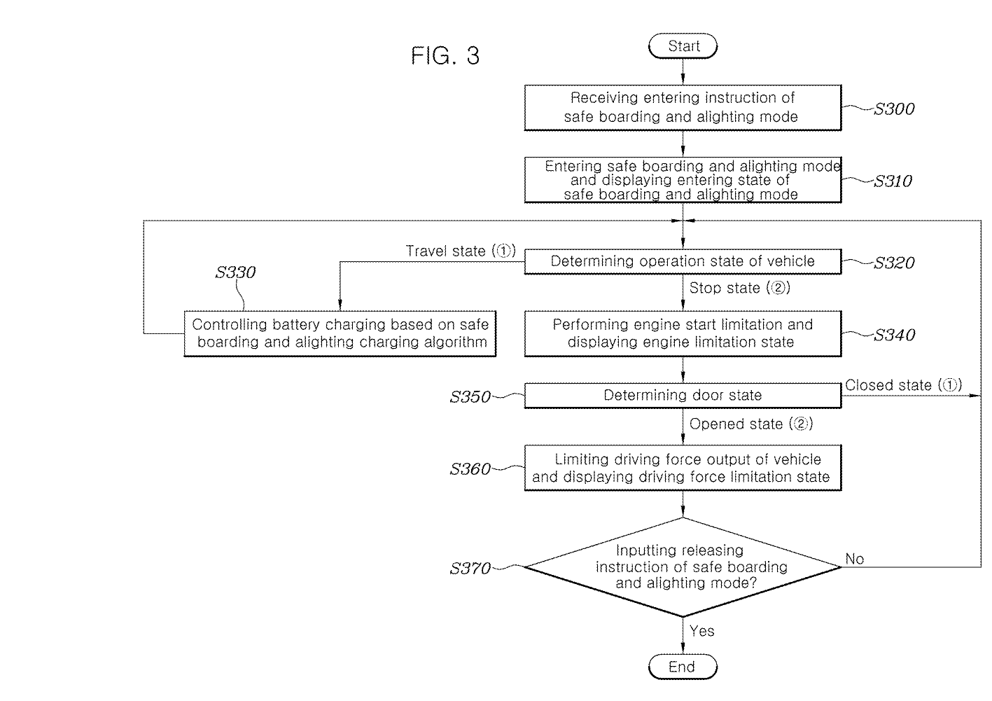

FIG. 3 is a view exemplarily illustrating a method for controlling the vehicle control apparatus 100 according to the exemplary embodiment of the present disclosure.

Referring to FIG. 3, when an instruction of entering the safe boarding and alighting mode is input through the user interface 110 at S300, the controller 130 may enter the safe boarding and alighting mode at S310.

According to the exemplary embodiment of the present disclosure, after entering the safe boarding and alighting mode, the controller 130 may indicate an entering state of the safe boarding and alighting mode through the user interface 110.

After entering the safe boarding and alighting mode, the controller 130 may be configured to determine the operation state of the vehicle 1 at S320.

At S320, the controller 130 may be configured to determine whether the vehicle 1 is in the travelling state or the stop state.

At S320, the controller 130 may be configured to determine the operation state of the vehicle 1 based on the vehicle speed information, the transmission gear position information, the emergency light state information, and the like.

When the vehicle 1 is in the travelling state at S320-①, the controller 130 may be configured for controlling battery charging of the vehicle 1 based on the preset safe boarding and alighting charging algorithm at S330.

At S330, the controller 130 may be configured for controlling charging of the battery so that the battery SOC value reaches the preset safe boarding and alighting charging target SOC value.

When the vehicle 1 is in the stop state at S320-②, the controller 130 may perform the engine start limitation at S340.

According to the exemplary embodiment of the present disclosure, the controller 130 may stop operation of the engine, and indicate the engine limitation state (or engine stop state) through the user interface 110.

Thereafter, the controller 130 may be configured to determine the door state based on the door state information at S350. At S350, the controller 130 may be configured to determine whether the door of the vehicle 1 is in an opened or closed state.

When the door of the vehicle 1 is in the closed state at S350-①), the controller 130 may perform the determination of the operation state at S320.

When the door of the vehicle 1 is in the opened state at S350-②, the controller 130 may limit the driving force output of the vehicle 1 at S360. According to the exemplary embodiment of the present disclosure, the controller 130 may output the driving force limitation state through the user interface 110.

At S360, the controller 130 may maintain the transmission gear in the N position. Furthermore, the controller 130 may allow the electronic parking brake (EPB) to be engaged.

Thereafter, when the instruction of releasing the safe boarding and alighting mode is input at S370-Yes, the controller 130 terminates the safe boarding and alighting mode. When the instruction of releasing the safe boarding and alighting mode is not input at S370-No, the controller 130 may perform the determination of the operation state at S320.

According to the exemplary embodiment of the present disclosure, the controller 130 may terminate the safe boarding and alighting mode when the instruction of releasing the safe boarding and alighting mode is input even in performing S320 to S360.

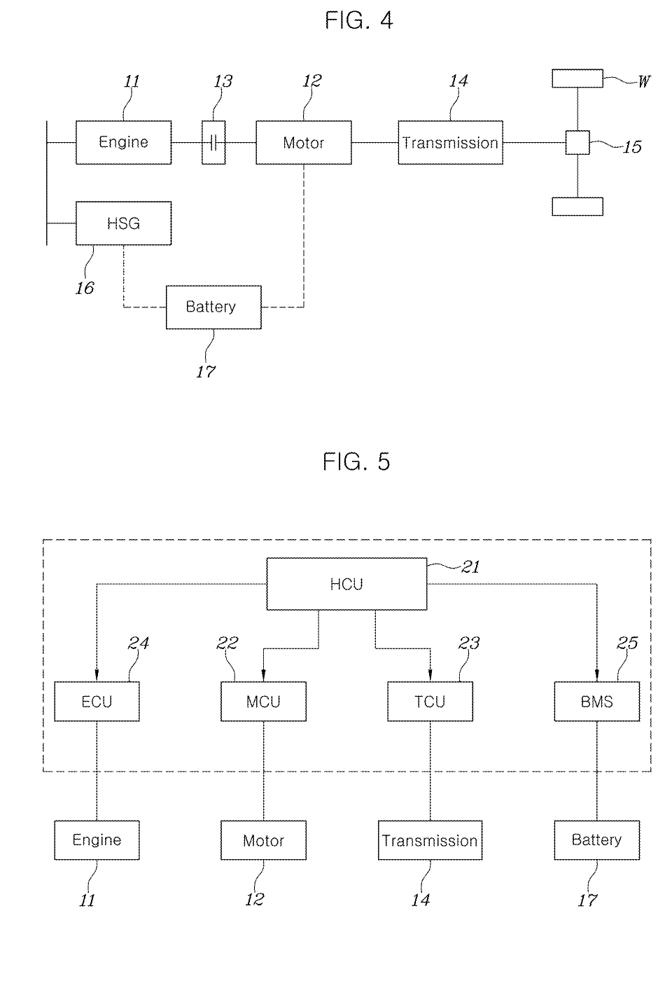

FIG. 4 is a view showing a power system of the vehicle 1 to which the vehicle control apparatus 100 according to the exemplary embodiment of the present disclosure is applied, and the view illustrates a transmission mounted electric drive (TMED) system.

Referring to FIG. 4, the vehicle power system may include an engine 11, a motor 12, an engine clutch 13 disposed between the engine 11 and the motor 12 and transmitting or cutting off engine power, a transmission 14 transmitting or outputting power of the motor 12, a final reduction gear 15 coupled to the transmission 14 and transmitting power of the transmission 14 to the driving wheel W, a hybrid starter generator (HSG) 16 connected to the engine 11 to start the engine and generate power, a battery 17 connected to the motor 12 and the hybrid starter generator 16 to be chargeable or dischargeable, and the like.

According to the exemplary embodiment of the present disclosure, the transmission 14 may be implemented into an auto transmission (AT), a dual clutch transmission (DCT), and the like.

FIG. 5 is a view showing a control block diagram for realizing control of the vehicle 1 according to the exemplary embodiment of the present disclosure.

Referring to FIG. 5, the vehicle control apparatus may include a hybrid control unit (HCU) 21, a motor control unit (MCU) 22, a transmission control unit (TCU) 23, an engine control unit (ECU) 24, a battery management unit (BMS) 25, and the like.

The hybrid control unit 21 is a higher controller that outputs a torque command according to a travelling condition, and may be configured for controlling a motor control unit 22, a transmission control unit 23, an engine control unit 24, and a battery management unit 25, which are lower controllers.

For example, the hybrid control unit 21 may communicate with a vehicle network, for example, communicate with the lower control unit 22, 23, 24, 25 based on a Controller Area Network (CAN).

The hybrid control unit 21 may perform control with respect to the lower control units 22, 23, 24, and 25, and receive information related to the devices 11, 12, 14, and 17, which are managed and controlled by the lower control unit 22, 23, 24, 25, from the lower control unit 22, 23, 24, 25.

According to the exemplary embodiment of the present disclosure, when the vehicle enters the safe boarding and alighting mode, the hybrid control unit 21 may be configured to determine the operation state of the vehicle 1.

When the vehicle is in the travelling state, the hybrid control unit 21 may output the entering instruction of the safe boarding and alighting mode to the battery management unit 25. Accordingly, the battery management unit 25 may enter the safe boarding and alighting mode, and control charging of the battery 17 based on the preset safe boarding and alighting charging algorithm.

Accordingly, the hybrid control unit 21 may perform the engine start limitation when the vehicle 1 is in the stop state. The hybrid control unit 21 may transmit an instruction of entering the safe boarding and alighting mode to the engine control unit 24, and the engine control unit 24 may enter the safe boarding and alighting mode and stop operation of the engine 11.

According to the exemplary embodiment of the present disclosure, when the door of the vehicle 1 is opened in the safe boarding and alighting mode, the hybrid control unit 21 may limit the driving force output of the vehicle 1. The hybrid control unit 21 may output an N-position maintaining order to the transmission control unit 23.

The motor control unit 22 may receive a torque order of the hybrid control unit 21, and control overall operation with respect to the motor 12.

The transmission control unit 23 may be configured for controlling a shift position of the transmission 14 according to a travelling situation, and the engine control unit 24 may be configured for controlling an overall operation and an operating point of the engine 11 according to the order of the hybrid control unit 21, and the battery management unit 25 may collect battery state information and use the information to control charging and discharging of the battery 17 or provide the information to the hybrid control unit 21.

Although the specific embodiments of the present disclosure have been provided, it is apparent to one of ordinary skill in the art that the present disclosure may be changed and modified in various ways without departing from the scope of the present disclosure, which is provided in the following claims.

What is claimed is:

1. An apparatus for controlling a hybrid vehicle, the apparatus comprising:
a hybrid powertrain including an engine and a drive motor; and
a controller determining an operation state of the vehicle according to vehicle state information based on entering a safe boarding and alighting mode, and maintaining the engine in an OFF state and limiting a driving force output of the hybrid powertrain based on that the operation state of the vehicle is in a boarding and alighting available state.

2. The apparatus of claim 1, wherein the boarding and alighting available state is a state in which a stop condition is satisfied with a door of the vehicle opened.

3. The apparatus of claim 1, wherein, based on that the stop condition is satisfied, the controller controls the engine so that the engine is maintained in the OFF state.

4. The apparatus of claim 1, wherein based on that the door of the vehicle is opened, the controller limits the driving force output of the hybrid powertrain.

5. The apparatus of claim 1, wherein, based on entering the safe boarding and alighting mode, the controller controls a battery so that a state of charge (SOC) value of the battery reaches a preset safe boarding and alighting charging target SOC value.

6. The apparatus of claim 5, wherein the preset safe boarding and alighting charging target SOC value is preset greater than or equal to electric power consumed by an electric field load of the vehicle based on that the vehicle is in a stop state.

7. The apparatus of claim 1, wherein based on that the operation state of the vehicle is in the stop state, the controller determines a door state of the vehicle based on a door state information, and based on that the door state of the vehicle is an open state, the controller limits the driving force output of the hybrid powertrain.

8. The apparatus of claim 1, wherein based on that the driving force output of the hybrid powertrain is limited, the controller controls a transmission gear of the vehicle so that the transmission gear is maintained in a Neutral (N) position.

9. The apparatus of claim 1, wherein based on that the driving force output of the hybrid powertrain is limited, the controller controls an electronic parking brake of the vehicle so that the electronic parking brake is in an engaged state.

10. The apparatus of claim 1, wherein the controller comprises:
a communication module communicating with electronic devices in the vehicle;
a memory storing at least an algorithm of performing the safe boarding and alighting mode; and
a processor configured for entering the safe boarding and alighting mode, and performing the algorithm of performing the safe boarding and alighting mode.

11. A method for controlling a hybrid vehicle including a hybrid powertrain of an engine and a drive motor, the method being performed by a processor operated based on an algorithm of performing a safe boarding and alighting mode, which is stored in a memory, the method comprising:
entering the safe boarding and alighting mode;
determining a vehicle operation state based on vehicle state information; and
based on that the vehicle operation state is in a boarding and alighting available state, maintaining the engine in an OFF state and limiting a driving force output of the hybrid powertrain.

12. The method of claim 11, wherein the boarding and alighting available state is a state in which a stop condition is satisfied with a door of the vehicle opened.

13. The method of claim 11, wherein the maintaining of the engine in the OFF state is performed based on that the stop condition is satisfied.

14. The method of claim 11, wherein the limiting of the driving force output of the hybrid powertrain is performed based on that the door of the vehicle is opened.

15. The method of claim 11, further comprising: based on entering the safe boarding and alighting mode, controlling a battery of the vehicle so that a state of charge (SOC) value of the battery reaches a preset safe boarding and alighting charging target SOC value.

16. The method of claim 15, wherein the preset safe boarding and alighting charging target SOC value is set greater than or equal to electric power consumed by an electric field load of the vehicle based on that the vehicle is in a stop state.

17. The method of claim 11, wherein the limiting of the driving force output of the hybrid powertrain comprises maintaining a transmission gear of the vehicle in an N position.

18. The method of claim 11, wherein the limiting of the driving force output of the hybrid powertrain comprises maintaining an electronic parking brake of the vehicle in an engaged state.

19. A hybrid vehicle including a hybrid powertrain of an engine and a drive motor, the hybrid vehicle comprising:
a vehicle control apparatus which controls the hybrid vehicle according to a preset algorithm for performing a safe boarding and alighting mode, based on entering the safe boarding and alighting mode,
wherein the vehicle control apparatus determines an operation state of the vehicle based on vehicle state information, and based on that the vehicle operation state is in a boarding and alighting available state, the vehicle control apparatus maintains the engine in an OFF state and limits a driving force output of the hybrid powertrain.

20. The hybrid vehicle of claim 19, wherein the vehicle control apparatus comprises:
a user interface receiving an instruction of entering the safe boarding and alighting mode from a user; and
a controller including a processor entering the safe boarding and alighting mode, and performing the preset algorithm for performing the safe boarding and alighting mode.
